(19) United States
(12) Patent Application Publication
(10) Pub. No.: US 2026/0124922 A1
(43) Pub. Date: May 7, 2026

(54) Magnetic Snap, Latency Compensation Methods and Systems for Augmented Reality Automotive Displays

(71) Applicant: Basemark OY, Helsinki (FI)

(72) Inventor: Somasundharam Muthumanickam, Munich (DE)

(73) Assignee: Basemark OY, Helsinki (FI)

(21) Appl. No.: 19/379,856

(22) Filed: Nov. 5, 2025

Related U.S. Application Data
(60) Provisional application No. 63/716,302, filed on Nov. 5, 2024.

(51) Int. Cl. B60K 35/90; B60K 35/10; B60K 35/233; B60K 35/29; B60K 35/81

(52) U.S. Cl. CPC B60K 35/90; B60K 35/10; B60K 35/233; B60K 35/29; B60K 35/81; B60K 2360/177

(57) ABSTRACT

A system and method are disclosed for compensating display latency in augmented reality automotive head-up displays (AR-HUDs). The approach combines vehicle sensor signals with real-time camera edge detection to maintain accurate spatial alignment of virtual content. Virtual highlights derived from delayed sensor input are tracked and dynamically realigned by snapping them to detected image edges when spatial coincidence is identified, thereby reducing perceptual drift. This continuous correction improves overlay accuracy, enhances driver situational awareness, and contributes to overall driving safety.

### CROSS-REFERENCE TO RELATED APPLICATIONS

This application claims the benefit of priority under 35 U.S.C. § 119(e) to U.S. Provisional Ser. No. 63/716,302 , filed on Nov. 5, 2024, the entirety of which is hereby incorporated by reference in its entirety.

### BACKGROUND OF THE INVENTION

### Field of the Invention

The present invention relates generally to automotive display systems and, more particularly, to methods and systems for compensating latency in augmented reality head-up displays (AR-HUDs). In certain embodiments, the invention employs sensor data fusion, tracker with appearance, and/or image edge detection techniques to improve the spatial accuracy and responsiveness of virtual overlays in vehicle display environments.

### Description of Related Art

Head-up displays (HUDs) are increasingly deployed in modern vehicles to improve safety and driver comfort by projecting critical information within the driver's natural line of sight. Augmented reality (AR) HUDs extend this functionality by superimposing virtual objects, such as navigation cues, lane markings, collision warnings, and vehicle highlights, directly onto the windshield. By anchoring digital content to corresponding real-world positions, AR-HUDs allow drivers to maintain focus on the road while simultaneously receiving situational information.

However, one of the key challenges facing AR-HUD deployment is latency. In this context, latency refers to the delay between a real-world change (such as the sudden deceleration of a leading vehicle) and the corresponding update of the AR overlay. Even modest latencies can produce noticeable misalignment between virtual and physical objects, resulting in reduced driver trust, distraction, or motion discomfort. In severe cases, latency artifacts may undermine the safety benefits of the system.

Latency in AR-HUD systems arises from multiple sources. Starting in no particular order, a first source is sensor processing latency, namely, advanced driver-assistance system (ADAS) sensors, such as radar, lidar, and ultrasonic sensors, provide highly accurate positional information but require sensor fusion and interpretation on a system-on-chip (SoC). This process introduces typical delays of 80-150, up to 250-300 milliseconds. Another source is rendering latency, namely, the AR subsystem must generate perspective-correct overlays in real time. Complex rendering pipelines for high-fidelity overlays increase computational load and slow response time. Then there is data transmission latency, namely, positional data and rendering commands are exchanged across in-vehicle networks (e.g., CAN, automotive Ethernet).

Transmission overhead and arbitration delays add further latency. Lastly, but not completely, there is display refresh latency, namely, the HUD display hardware updates overlays at discrete refresh intervals (e.g., 60 Hz). Even when upstream processing is optimized, the refresh rate may limit perceived responsiveness.

Existing approaches attempt to balance these trade-offs. ADAS-based rendering offers high accuracy but suffers from delays. Camera-based overlays respond quickly but may misidentify or drift under adverse conditions such as low lighting, rain, or occlusion.

Predictive techniques partially compensate for latency but are computationally expensive and prone to errors in dynamic driving environments.

As AR-HUDs become physically larger and capable of presenting more contextual information, the effect of latency is amplified. Even small mismatches between virtual and physical objects can span large regions of the windshield, leading to distracting “swimming” overlays and driver discomfort. This creates a technical bottleneck: manufacturers must compromise between accuracy and responsiveness, thereby limiting the safety and usability of next-generation AR-HUDs.

### BRIEF SUMMARY OF THE INVENTION

The present invention provides methods, systems, and computer-implemented techniques for compensating latency in augmented reality head-up displays (AR-HUDs). Conventional AR-HUD approaches either rely on advanced driver-assistance system (ADAS) sensor data, which is accurate but delayed due to complex fusion pipelines, or camera-based detection, which is responsive but less reliable. The invention overcomes these limitations by combining both sources of information in a complementary manner.

In one aspect, an AR-HUD system includes: at least one vehicle sensor system (e.g., radar, lidar, ultrasonic sensors, or combinations thereof) configured to provide positional data of surrounding objects; a forward-facing camera configured to capture real-time images of the driving environment; a processor operable to receive and fuse the sensor data and camera images, execute a tracker with appearance and/or an edge detection algorithm on the camera images, and determine whether a virtual object derived from the delayed sensor data should be adjusted; and a head-up display configured to render virtual overlays into the driver's field of view.

In operation, the processor renders a virtual highlight (e.g., a bounding box around a leading vehicle) based on ADAS sensor input. Because of sensor pipeline delays, the highlight may not precisely align with the actual object. To correct this, the processor monitors perform appearance-based tracking in case the overall pipeline delay is known and/or spatial proximity between the virtual highlight and the nearest physical edge detected in the real-time camera image in case of unknown or floating delay. When the difference falls within a configurable “snap threshold,” the system realigns the virtual highlight to coincide with the detected edge.

The snapping process may employ adaptive thresholds, temporal filtering, or hysteresis logic to avoid jitter or spurious corrections. In some embodiments, predictive modeling (e.g., trajectory forecasting using historical data) is applied to anticipate future object positions, further reducing perceived latency. The system may also prioritize dynamic objects such as vehicles or pedestrians for rapid compensation, while updating static overlays such as road signs or lane markings less frequently.

By integrating these features, the invention enables AR-HUDs to deliver overlays that remain visually stable, accurate, and responsive even as display areas become larger and more complex. This approach reduces driver distraction, mitigates motion discomfort caused by latency artifacts, and permits the presentation of richer contextual information—such as navigation cues, hazard alerts, and vehicle highlights, without forcing manufacturers to choose between accuracy and responsiveness.

### BRIEF DESCRIPTION OF THE SEVERAL VIEWS OF THE DRAWINGS

Further advantageous features and details of the various embodiments of this disclosure will become apparent from the ensuring description of a preferred exemplary embodiment or embodiments and further with the aid of the drawings. The features and combinations of features recited below in the description, as well as the features and feature combination shown after that in the drawing description or in the drawings alone, may be used not only in the particular combination recited by also in other combinations on their own without departing from the scope of the disclosure, wherein:

FIG. 1 is a schematic diagram of an augmented reality head-up display (AR-HUD) system with object highlighting based on advanced driver-assistance system (ADAS) data;

FIG. 2 is a schematic diagram of an AR-HUD system with object detection based on a forward-facing camera; and

FIGS. 3A and 3B are conceptual illustrations of a latency compensation process in which a virtual highlight is dynamically aligned with a tracked object and/or detected real-world edge.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of “A, B, and C”.

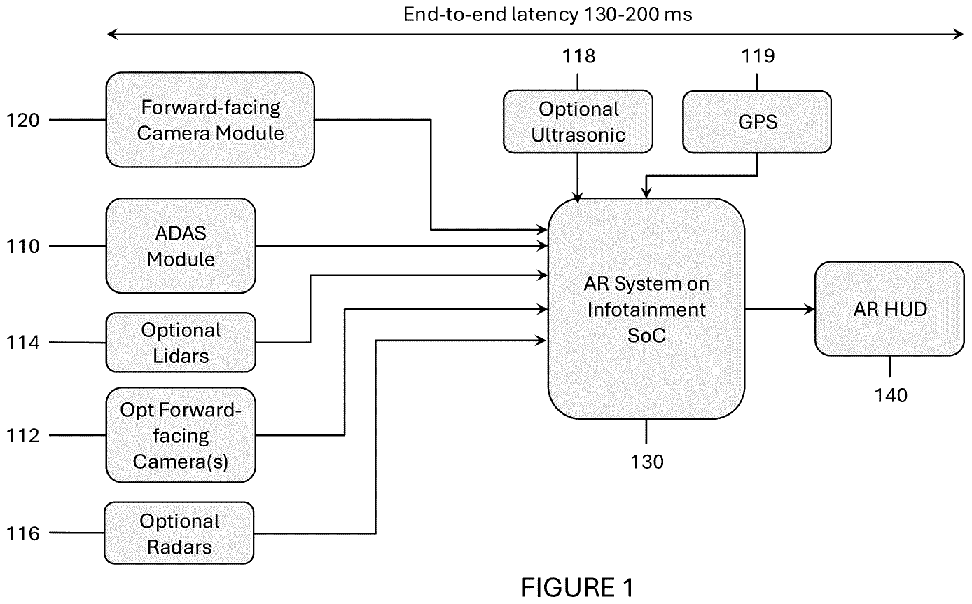

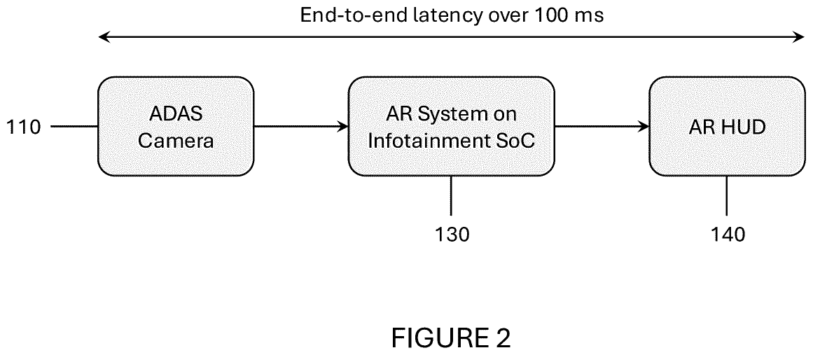

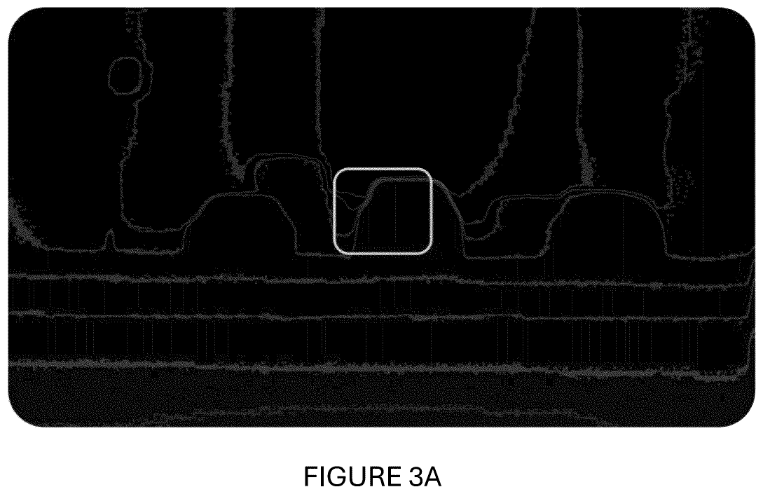

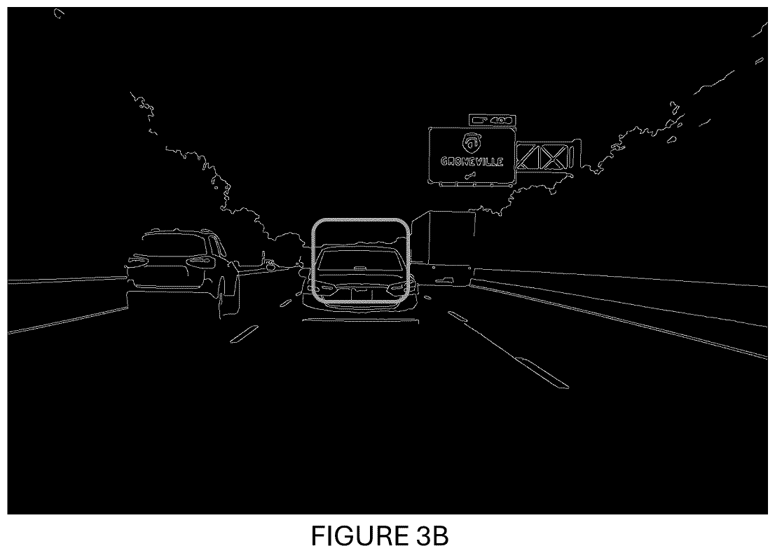

The present disclosure provides an augmented reality head-up display (AR-HUD) system and method for automotive applications that compensates for latency in the rendering of virtual content. In certain embodiments, the system integrates data from an advanced driver-assistance system (ADAS), a forward-facing camera, and a dedicated processing unit to generate augmented overlays that remain spatially aligned with corresponding real-world objects. By employing tracker with appearance and/or edge detection on real-time camera imagery and applying a “magnetic snap” realignment algorithm, the system reduces the apparent delay between sensor-derived object highlights and their physical counterparts. As a result, augmented reality content, such as vehicle bounding boxes, navigation cues, and hazard warnings, is presented to the driver in a manner that is both accurate and responsive, thereby enhancing safety and situational awareness. Illustrative embodiments are shown in FIGS. 1-3 and described in greater detail below.

The present invention relates to an automotive augmented reality (AR) head-up display (HUD) system configured to compensate for latency in the rendering of AR elements. The system integrates data from an advanced driver-assistance system (ADAS), at least one forward-facing camera, and a dedicated processing unit. By combining these inputs, the architecture ensures that virtual objects and highlights provided to the driver remain spatially aligned with real-world objects, thereby enhancing safety, comfort, and situational awareness.

Having introduced the overall AR-HUD system architecture, it is helpful to examine its constituent modules in greater detail, beginning with the advanced driver-assistance system (ADAS) sensors, which form the foundation of object detection and tracking. The ADAS module includes a suite of vehicle sensors, such as radar, lidar, ultrasonic sensors, and computer vision systems, configured to detect and track vehicles, pedestrians, and environmental features. The ADAS system continuously calculates object positions and trajectories in the vehicle's surroundings and communicates this information to the central processor. While ADAS sensor fusion provides highly accurate positional data, it typically incurs processing delays on the order of 0.08-0.15 seconds due to data aggregation and interpretation pipelines.

To supplement this input, the system incorporates at least one forward-facing camera that captures real-time images of the driving environment. The camera provides direct visual data that can corroborate or refine the ADAS coordinates. Appearance-based tracker, such as Simple Online and Realtime Tracking (SORT) or it's modifications, and/or edge detection algorithms, such as the Canny edge detector, are executed on the camera feed to extract high-contrast object boundaries visible through the windshield. This process enables low-latency identification of physical features, though environmental conditions (e.g., rain, glare, or occlusion) may reduce reliability compared to sensor fusion.

While the forward-facing camera provides immediate visual input, effective latency compensation requires a coordinating element. This role is fulfilled by the central processor, which unifies data streams and applies realignment logic. The processor operates as the central controller for AR content generation and latency compensation. It receives ADAS object coordinates and camera image data concurrently, executing sensor fusion and predictive algorithms to maximize spatial accuracy. A configurable threshold parameter is employed whereby ADAS-based virtual highlights are “snapped” onto refined object position or detected physical edges in the camera image once the calculated position falls within a predetermined spatial proximity. The processor prioritizes dynamic objects, such as moving vehicles, for rapid updates, while static features are updated less frequently to conserve computational resources. In addition, predictive modeling and efficient rendering strategies are implemented to further reduce perceived lag and ensure smooth transitions in AR content.

The HUD is positioned within the driver's natural line of sight, typically by projection onto the windshield. It overlays AR content such as vehicle highlights, navigation cues, and hazard warnings onto the real-world scene. The HUD refreshes content at high frame rates to minimize delay and visual artifacts. By continuously receiving updated input from the processor, the HUD adjusts the placement and appearance of AR annotations in real time. The combined use of sensor-based data, camera-based image analysis, and latency compensation mechanisms—including the “magnetic snap” algorithm—ensures that overlays remain accurate, stable, and responsive during dynamic driving conditions.

The disclosed AR-HUD system operates through an integrated data flow that combines sensor-based information with real-time image analysis to maintain accurate and responsive virtual overlays. The workflow proceeds as follows:
Object Detection via ADAS, namely, the ADAS sensors detect and track surrounding objects, such as vehicles and pedestrians, and transmit positional and trajectory data to the central processor;
Camera Image Acquisition, namely, a forward-facing camera provides real-time images of the environment, which are processed using tracker with appearance and/or edge detection algorithms to track object movement and extract object boundaries and contours;
Sensor Fusion and Compensation, namely, the processor fuses ADAS coordinates with visual object tracking and/or camera-derived edge data while applying predictive modeling and latency compensation logic;
Magnetic Snap Alignment, namely, when the ADAS-tracked position of an object adjusted by appearance-based tracker approaches a corresponding real-world edge in the image stream, the processor invokes the magnetic snap algorithm to align the virtual highlight with the detected edge; and/or
HUD Projection, namely, the HUD continuously renders and displays compensated AR content, maintaining spatial fidelity between virtual annotations and physical objects, thereby reducing perceived latency for the driver.

This architecture mitigates latency issues inherent in large and complex AR-HUDs while enabling the presentation of richer, contextually relevant information in a manner that is both non-distracting and safety-enhancing. Through the combined use of hardware integration and advanced software techniques, the system ensures that AR overlays remain accurate, stable, and responsive under a wide range of driving conditions.

The disclosed architecture addresses latency management in augmented-reality head-up display (AR-HUD) systems by integrating multiple sensor inputs and compensating for temporal misalignment. Because AR-HUDs occupy increasingly larger display areas, even modest timing discrepancies between sensor subsystems may result in perceptible positional errors that distract the driver.

In one embodiment, the architecture includes an integrated sensor fusion module (110) configured to combine data from an advanced driver-assistance system (ADAS) module (120) and a camera subsystem (130). The ADAS module (120) is adapted to provide highly accurate positions and trajectories of dynamic road objects, but its signals are subject to inherent processing delays on the order of approximately 80 to 150 milliseconds due to multi-sensor fusion and interpretation pipelines. By contrast, the camera subsystem (130) is operable to deliver immediate visual context and to perform appearance-based tracker and/or edge and object detection with minimal delay, albeit at reduced precision and with increased susceptibility to environmental factors such as lighting and weather.

By fusing these complementary inputs, the sensor fusion module (110) achieves both positional accuracy and low-latency responsiveness. The ADAS module (120) ensures reliable object identification and tracking, while the camera subsystem (130) provides rapid visual cues that enable correction for temporal misalignment. This integration is particularly critical in large-format AR-HUDs, where latency-induced errors become perceptible to the user and may impair driver comfort and situational awareness.

The disclosed architecture manages latency in augmented-reality head-up displays (AR-HUDs) by integrating complementary sensor inputs and compensating for temporal misalignment. In large-format AR-HUDs, even small timing offsets between subsystems can cause visible positional drift, which risks distracting the driver.

In one embodiment, integrated sensor fusion combines data from an advanced driver-assistance system (ADAS) module (110) with real-time input from a forward-facing camera (120). The ADAS module (110) provides highly accurate object positions and trajectories, but its signals are subject to inherent processing delays of approximately 80-150 milliseconds due to multi-sensor fusion and interpretation pipelines. In contrast, the camera subsystem (120) delivers immediate visual context and enables rapid edge and object detection with minimal delay, albeit at lower precision and with greater susceptibility to environmental factors.

By combining these complementary inputs, the system achieves both accuracy and responsiveness. The ADAS module (110) ensures reliable object identification and tracking, while the camera (120) provides low-latency visual cues that allow the processor (130) to correct for temporal misalignment. This fusion is particularly critical in large-format AR-HUDs (140), where latency-induced misalignment becomes perceptible.

Yet even with multi-sensor fusion, temporal discrepancies remain. To address these residual offsets, the architecture incorporates a corrective alignment mechanism referred to as ‘Magnetic Snap.’ To further minimize perceptible lag after initial sensor fusion, the system implements a corrective alignment mechanism, described below as “magnetic snap.”

A corrective mechanism termed magnetic snap intelligently compensates for residual sensor and rendering latency. As ADAS-highlighted objects (110a) approach the true position of corresponding features detected by the camera (120a), such as the outline of a leading vehicle, the processor (130) computes spatial proximity using configurable thresholds. When the offset between the virtual highlight tracked by appearance-based tracking and the detected edge exceeds a perceptible limit, the processor (130) dynamically “snaps” the overlay onto the camera-derived edge.

Although magnetic snap compensates for upstream latency, the final presentation to the driver depends equally on the capabilities of the display subsystem, which introduces its own timing considerations such as refresh cycles. This snapping process ensures that augmented highlights presented in the HUD (140) remain visually aligned with real-world features, even when sensor fusion introduces slight temporal lag. As a result, the AR-HUD can display dynamic contextual information across larger projection areas without distracting the driver through noticeable misplacement of virtual elements, thereby providing a more natural and engaging experience.

In addition to correcting spatial alignment, the system also manages the rendering workload to ensure that contextual content remains both relevant and responsive. The architecture employs predictive algorithms and selective rendering logic executed by the processor (130) to prioritize the most relevant augmented-reality (AR) elements, such as navigation cues (150a), hazard alerts (150b), and lane markers (150c), over less critical content. Techniques such as level-of-detail management and dynamic update rates ensure that overlays remain smooth and non-distracting, even when displaying a broader set of contextual information.

To optimize responsiveness, the processor (130) differentiates between static objects (e.g., lane boundaries and road signs 160) and dynamic objects (e.g., vehicles 170). Static elements are updated at lower frequencies, conserving computational resources, while dynamic elements are refreshed at higher rates to maintain accurate tracking. This selective rendering reduces processing load, minimizes perceived latency.

This selective rendering reduces processing load, minimizes perceived latency, and ensures that time-critical visual cues remain highly responsive within the head-up display (140).

Complementing these measures, the display subsystem itself is configured to maintain visual consistency from the driver's perspective, even as sensor and processing latencies vary.

The HUD display subsystem (140) automatically synchronizes virtual overlays with real-time changes in the vehicle's environment. By operating at high refresh rates (e.g., 90-120 Hz) and implementing adaptive brightness control, the subsystem aligns augmented elements with both ambient lighting conditions and dynamic driver perspective. These features minimize visual inconsistencies that can otherwise induce distraction or motion discomfort, particularly in larger-format head-up displays.

Together, these synchronization measures enable large-scale AR-HUDs to present complex and engaging contextual information, such as navigation paths (150a), hazard alerts (150b), and dynamic object highlights (170), without compromising driver safety or comfort.

As outlined above, one major contributor to latency arises within the sensor acquisition and preprocessing stages themselves.

The AR-HUD architecture integrates data from multiple vehicle sensors, including forward-facing cameras (112), lidar (114), radar (116), ultrasonic transducers (118), and GPS modules (119). Each of these subsystems operates with its own acquisition cycle and internal preprocessing pipeline. For example, radar and lidar signals require noise filtering and object clustering, while camera streams demand tracking by appearance, edge detection and feature extraction.

In a representative embodiment, raw sensor data are first preprocessed within the local sensor module, then transmitted via the in-vehicle data bus (120) to the central processor (130). When multiple modalities are employed, sensor fusion and object classification are typically executed on a system-on-chip (SoC) or comparable microcontroller integrated with the processor (130).

The cumulative effect of acquisition, preprocessing, and fusion introduces latency ranging from tens to several hundreds of milliseconds. This temporal offset propagates downstream into the AR rendering pipeline, delaying alignment of virtual annotations with corresponding real-world features. Without compensation, such delays may cause perceptible misplacement of overlays on the head-up display (140), reducing driver trust and situational awareness.

In addition to sensor pipeline delays, a further significant contributor to AR-HUD latency arises during the generation of virtual graphical content.

Once relevant objects and environmental features have been identified by the processor (130), the augmented reality system must generate contextually accurate overlays, such as bounding boxes (150), navigation cues (152), hazard warnings (154), and supplementary driver-assistance data (156). These virtual elements are transformed into perspective-correct projections that align with the real-world scene visible through the windshield.

Rendering high-fidelity AR graphics in real time requires substantial computational resources. The graphics processing unit (132) or an equivalent rendering module executes geometric transformations, edge alignment, and shading operations to ensure visual consistency with the driver's field of view. When multiple overlays are generated simultaneously, particularly in expanded or large-format AR-HUDs, the computational load can increase sharply.

If processor or GPU resources are constrained, rendering latency may rise perceptibly, often constituting a dominant component of the total end-to-end delay. This may manifest as overlays that “lag behind” the driver's real-time perception of the environment, undermining spatial coherence and causing distraction or discomfort.

In addition to computational delays introduced during sensor processing and rendering, latency can also accumulate during the transfer of processed data and graphical overlays between subsystems. This stage, referred to as transmission latency, reflects the time consumed as information travels across internal data buses, interconnects, or network links within the vehicle.

In the disclosed architecture, sensor outputs from the ADAS module (120), camera subsystem (122), and related electronic control units (124) are transmitted to the central processor (130), where object fusion and AR rendering are performed. Following rendering, graphical instructions must be delivered to the display controller (134) for projection onto the windshield or combiner surface (110). Each transfer involves serialization, buffering, and protocol overhead, introducing measurable latency even in optimized systems.

Modern in-vehicle networks such as Automotive Ethernet reduce this latency compared to legacy Controller Area Network (CAN) protocols, yet protocol processing and bus arbitration continue to impose non-negligible delays. Additional latency arises when multiple distributed ECUs exchange information, or when cloud-assisted services are used for high-level object recognition. Emerging low-latency technologies, such as 5G connectivity and next-generation display links, mitigate but do not fully eliminate these transmission delays.

By explicitly modeling and compensating for transmission latency in conjunction with sensor and rendering delays, the present system maintains AR overlay accuracy and prevents positional drift that might otherwise degrade driver situational awareness.

The final source of latency arises within the hardware display subsystem (110), which refreshes virtual overlays at discrete intervals determined by the refresh rate of the projection technology. Typical rates range from 30 Hz to 120 Hz depending on implementation. At lower refresh rates, perceptible lag occurs because positional changes in AR content must wait for the next refresh cycle before becoming visible to the driver. Even at higher refresh rates, such as 120 Hz, small mismatches between sensed reality and rendered overlays can still be detected, particularly in large-format or wide field-of-view AR-HUDs.

The disclosed architecture accounts for this limitation by aligning display refresh timing with sensor fusion and rendering updates. In particular, the processor (130) issues synchronized update instructions to the display controller (134), ensuring that newly computed AR overlays are queued for the next available refresh cycle with minimal delay. By harmonizing computational pipelines with the display subsystem's update cadence, positional drift is reduced and the overlays appear more stable to the human eye.

These measures are especially critical as AR-HUDs expand in display size and resolution, where even slight temporal misalignment across the windshield surface can lead to visually distracting “swimming” effects. By mitigating refresh-induced lag, the invention enables smoother, more natural presentation of navigation cues, collision warnings, and contextual highlights.

Having detailed the origins of latency across the sensing, rendering, and transmission stages, the description now turns to the invention's compensatory process: a tracker with appearance and/or an edge detection and realignment (‘snap’) technique that directly corrects visible misalignment. While the foregoing subsections describe the primary sources of latency inherent to AR-HUD systems, the present disclosure introduces a compensatory mechanism that actively mitigates these delays. Specifically, an edge detection and realignment process, referred to herein as the “snap” process, ensures that AR overlays remain visually aligned with corresponding real-world objects despite temporal discrepancies across the sensor, rendering, transmission, and display pipelines.

The disclosed AR-HUD latency compensation architecture employs a hybrid algorithm referred to herein as “Magnetic Snap”, which corrects misalignment of virtual objects caused by latency in upstream ADAS sensor data and other system delays. Through this process, virtual highlights—such as vehicle bounding boxes, navigation cues, or hazard indicators, remain visually synchronized with their corresponding real-world counterparts, even when sensor inputs arrive with perceptible lag.

A forward-facing camera subsystem (110) continuously captures real-time images of the vehicle's forward field of view. Each image frame is processed by a tracker with appearance, such as SORT algorithm, and/or an edge detection algorithm (112), such as a Canny edge detector, selected for its balance of computational efficiency and accuracy in delineating object boundaries under diverse lighting and weather conditions. The output of this processing step are an updated position of virtual object and/or an edge map (114) comprising contours and feature boundaries of external objects, including lane markers, road edges, pedestrians, and, most critically, vehicle silhouettes.

Concurrently with tracking and/or edge map processing, the AR processor (120) receives object coordinate data from the ADAS module (102). Because the ADAS relies on multi-sensor fusion and higher-level interpretation pipelines, these coordinates may arrive with a latency in the range of approximately 80-150 milliseconds. Based on this input, the processor generates a virtual highlight (122), such as a colored bounding box, for example, a blue rectangle, designed to visually emphasize a vehicle or other tracked object.

In practice, this virtual highlight is initially positioned according to the delayed ADAS coordinates, and may therefore exhibit a spatial offset relative to the object's true real-world location. This positional misalignment represents the core latency problem addressed by the disclosed architecture.

To correct the spatial misalignment introduced by ADAS latency, the system employs a Magnetic Snap algorithm (124) executed by the processor (120). The algorithm continuously evaluates the spatial relationship between the projected position of the virtual highlight (122), derived from ADAS coordinates and tracked, and the nearest edge detected in the real-time camera feed (104).

When the tracked and/or projected highlight approaches within a configurable snap threshold (126), the processor dynamically repositions the highlight to coincide with the corresponding real-world edge extracted from the camera image. This threshold is calibrated to balance responsiveness against stability, ensuring that overlays are adjusted only when proximity indicates reliable correspondence while avoiding spurious or jittery movements.

The realignment is performed seamlessly and in real time, so the transition appears smooth and natural to the driver. As a result, the augmented overlay remains perceptually locked to its physical counterpart, eliminating distracting lag and preserving immersion even under conditions of high sensor latency or rapid object motion.

The snap threshold (126) is configurable by either the end user or the original equipment manufacturer (OEM), allowing adjustment of the system's sensitivity according to factors such as HUD size, sensor latency characteristics, and the desired aggressiveness of overlay realignment. This tunability enables the architecture to be deployed across different vehicle platforms while maintaining consistent driver experience.

To further ensure stability, the processor (120) applies additional control logic, such as temporal filtering or hysteresis functions (128), which suppress rapid oscillation or jitter that may otherwise result from fluctuating edge detection data. These measures allow the Magnetic Snap algorithm (124) to disregard transient noise or momentary occlusion in the camera signal (104), thereby preserving a steady and visually coherent overlay.

As a result, the system maintains both responsiveness and visual stability, ensuring that AR highlights remain perceptually locked to their corresponding real-world objects without introducing distracting or unnatural motion artifacts.

The Magnetic Snap process (124) enables the AR-HUD to deliver highly accurate, real-time overlays of dynamic contextual information. This capability becomes particularly valuable as AR-HUDs increase in size and complexity, since larger display fields make latency artifacts more noticeable to the driver. By ensuring that virtual highlights reliably track moving real-world objects, the system provides an immersive, engaging, and safe user experience while requiring only modest computational overhead.

To further minimize perceived latency, the processor (120) employs predictive algorithms (130) that estimate future positions and trajectories of both the host vehicle and surrounding objects. By analyzing historical data from the ADAS (102) and camera (104) subsystems, the system forecasts driving events such as acceleration, braking, or lane changes. Using these forecasts, the processor can pre-render virtual overlays, including warnings, navigational cues, and object highlights, before the physical scene has changed.

This proactive rendering reduces the temporal gap between real-world motion and virtual display updates, thereby maintaining responsiveness and enhancing driver safety. The combination of Magnetic Snap correction (124) and predictive modeling (130) ensures that the AR-HUD system not only reacts quickly to sensor input but also anticipates environmental changes, delivering a smooth, reliable, and distraction-free augmented driving experience.

The system further enhances accuracy through sensor fusion (132), which integrates data streams from multiple modalities, including the ADAS subsystem (102), forward-facing camera (104), inertial measurement unit (IMU) (106), LiDAR (108), and GPS (110). By combining these complementary sources, the processor (120) constructs a robust, real-time model of the driving environment.

Each sensor contributes distinct advantages: the ADAS provides high-precision object detection and trajectory estimation; the camera delivers immediate visual context for appearance-based tracker and/or edge detection and visual confirmation; the IMU contributes inertial stability; LiDAR adds depth and shape information; and GPS supplies absolute positioning.

Through continuous fusion of these inputs, the system increases positional reliability, reduces the likelihood of missed detections, and ensures that virtual highlights projected on the HUD (114) remain accurately aligned with real-world objects-even under adverse environmental conditions or during partial sensor degradation.

These real-time correction mechanisms, when combined with predictive algorithms and sensor fusion, yield system-wide advantages that extend beyond local alignment, namely, a robust AR-HUD experience that remains accurate, stable, and responsive under diverse conditions. While real-time adjustment minimizes alignment errors caused by local motion or sensor fluctuations, another critical factor influencing AR stability is the timing of data transmission itself. Even when overlays are corrected instantly on-device, any delay in transmitting positional or sensor information across the system can introduce visible lag. This issue, known as transmission latency, directly affects the responsiveness and synchronicity of AR interactions, particularly in connected or multi-user environments.

By uniting predictive algorithms, sensor fusion, and real-time adjustment, the architecture achieves several key benefits, namely, it minimizes latency and misalignment that become problematic in larger and more complex AR-HUDs; enables a richer set of contextual AR content (navigation, hazard warnings, lane markers) to be presented in an engaging but non-distracting manner, even as the amount and complexity of information displayed on the AR-HUD increases; balances accuracy and responsiveness, delivering high precision from sensor fusion and immediate correction and adaptability from real-time adjustment techniques; and reduces computational demands by prioritizing essential predictive updates for dynamic elements, allowing for scalable and efficient operation as AR display areas and data volume grow. This multi-modal approach thus empowers OEMs to deliver next-generation AR-HUD experiences while safeguarding against latency-induced discomfort and driving distraction, and simultaneously supporting the display of vital contextual information for improved safety and user satisfaction.

Finally, it should be noted that the description of the invention and the exemplary embodiments are not to be understood as limiting in terms of a particular physical realisation of the invention. The scope of protection of the present invention is given by the claims and is not limited by the features illustrated in the description or shown in the figures.

What is claimed is:

1. A method for compensating latency in an automotive augmented reality head-up display (AR-HUD), comprising the steps of:
receiving object positional data from a vehicle sensor system;
capturing real-time image data from a vehicle-mounted camera;
deriving real-world features from the image data using an image analysis algorithm and/or tracking with appearance; and
correcting a displayed virtual object by snapping the virtual object highlight to a nearest feature boundary when a threshold proximity is met.

2. The method of claim 1, wherein the vehicle sensor system comprises one or more of radar, LiDAR, ultrasonic sensors, camera, IMU, or GPS.

3. The method of claim 1, wherein the camera is a monocular or stereo imaging sensor located forward-facing in the vehicle cabin.

4. The method of claim 1, wherein the image analysis algorithm comprises one or more of: a SORT, modified SORT, or equivalent image processing method, a Canny edge detector, a Sobel filter, a Laplacian operator, or another classical edge-based operator.

5. The method of claim 1, wherein the image analysis algorithm comprises a neural network-based model selected from object detection, instance segmentation, keypoint estimation, or multi-object tracking, the model outputting object proposals, instance masks, keypoints, or track identifiers used to compute proximity for snapping correction.

6. The method of claim 1, wherein:
the threshold proximity is variable and user-configurable for balancing responsiveness and spatial accuracy; and
snapping is performed with temporal filtering or hysteresis to prevent visual jitter.

7. The method of claim 1, further comprising: applying predictive modeling to forecast object trajectories and pre-render virtual overlays.

8. The method of claim 1, further comprising: rendering adaptive overlays based on context, including navigation cues, hazard alerts, and lane markers.

9. The method of claim 1, further comprising: transmitting sensor and camera data over automotive Ethernet or equivalent in-vehicle network protocols to minimize transmission latency.

10. The method of claim 1, further comprising: updating virtual overlays after each HUD display refresh cycle, with explicit compensation for all cumulative system latencies.

11. A system for compensating latency in automotive AR-HUD displays, comprising:
at least one vehicle sensor configured to provide object positional data;
at least one camera configured to capture real-time image data;
a processing unit for sensor fusion and predictive modeling;
a display configured to render virtual AR elements; and
a processor operable configured to realign virtual objects by: receiving object positional data from a vehicle sensor system; capturing real-time image data from the at least one camera; deriving real-world features from the image data using an image analysis algorithm and/or appearance-based tracking; and correcting a displayed virtual object by snapping a virtual object highlight to the nearest feature boundry when a threshold proximity is met.

12. The system of claim 11, wherein the processing unit is further configured to execute sensor fusion algorithms that combine high-accuracy and fast-response sensor outputs.

13. The system of claim 11, wherein the display comprises a windshield-integrated head-up display with high-refresh rates and adaptive brightness control.

14. The system of claim 11, wherein object snapping is applied only when a positional difference between virtual highlight and a detected feature boundry exceeds a predetermined latency threshold.

15. The system of claim 11, wherein dynamic objects including vehicles or pedestrians are prioritized for latency correction over static objects including road signs or markers.

16. The system of claim 11, further comprising a memory configured to store historical sensor data to enable predictive trajectory modeling.

17. The system of claim 11, wherein sensor fusion further comprises correlation logic configured to validate object identification across disparate sensors.

18. A computer-implemented method comprising the steps of:
fusing object positional data from multiple sensor modalities in an automotive AR-HUD, including ADAS data and real-time camera images;
deriving real-world features from the camera images using an image analysis algorithm;
prioritizing dynamic object rendering for latency-compensated overlays; and
updating virtual content alignment in response to real-world changes detected by the fused sensors and derived features.

19. The method according to claim 18, wherein real-time adjustments include dynamic resizing or recoloring of overlays based on contextual priority of detected objects.

20. The method according to claim 18, wherein the AR processor prioritizes computational resources for overlays rendered in the forward-view region visible to the driver.
